(19) United States
(12) Patent Application Publication
(10) Pub. No.: US 2013/0317069 A1
(43) Pub. Date: Nov. 28, 2013

(54) 2,4-(SUBSTITUTED AROMATIC)-1,3-OXAZOLINE COMPOUNDS AS A SEED TREATMENT TO CONTROL PESTS

(71) Applicant: Dow Agrosciences LLC, Indianapolis, IN (US)

(72) Inventors: Gerald B. Watson, Zionsville, IN (US); Vidyadhar B. Hegde, Carmel, IN (US)

(73) Assignee: DOW AGROSCIENCES LLC, Indianapolis, IN (US)

(21) Appl. No.: 13/887,041

(22) Filed: May 3, 2013

Related U.S. Application Data
(60) Provisional application No. 61/644,148, filed on May 8, 2012.

(51) Int. Cl. A01N 43/76; A01N 47/02

(52) U.S. Cl. CPC A01N 43/76; A01N 47/02
USPC 514/340; 514/374

(57) ABSTRACT

Methods of using 2,4-(substituted aromatic)-1,3-oxazoline compounds as a seed treatment to control pests, such as insects and mites.

### CROSS-REFERENCE TO RELATED APPLICATION

This application claims the benefit of U.S. Provisional Patent Application Ser. No. 61/644,148, filed May 8, 2012, the disclosure of which is hereby incorporated herein in its entirety by this reference.

### TECHNICAL FIELD

Embodiments of the present disclosure relate to methods of using 2,4-(substituted aromatic)-1,3-oxazoline compounds as a seed treatment to control pests are disclosed.

### BACKGROUND

There are more than ten thousand species of pests (e.g., insects and mites) that cause losses in agriculture. These agricultural losses amount to billions of U.S. dollars each year. Disadvantageously, pests can rapidly develop resistances to pesticides currently utilized in seed treatments. For example, hundreds of insect species and mite species are resistant to one or more insecticides and miticides. The development of resistance to some older pesticides (e.g., DDT, carbamates, organophosphates) is well known. However, resistance has also developed to some newer pesticides.

To mitigate resistance development, pesticide rotation partners and/or alternative pesticides are needed. It would, therefore, be desirable to be able to use other compounds as seed treatments to control pests, such as insects and mites.

### BRIEF SUMMARY

In accordance with one embodiment described herein, a method of controlling pests comprises contacting at least one seed with at least one 2,4-(substituted aromatic)-1,3-oxazoline compound, the at least one 2,4-(substituted aromatic)-1,3-oxazoline compound comprising the following chemical structure:

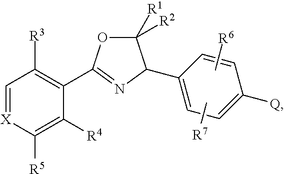

where R¹, R², R³, R⁴, and R⁵ independently comprise hydrogen (H), alkyl, haloalkyl, or halo; Q is selected from aryl, heteroaryl, substituted aryl, and substituted heteroaryl, wherein said substituents are selected from H, alkyl, haloalkyl, halo, alkoxy, and haloalkoxy and R⁶, R⁷, R⁸, and R⁹ independently comprise H, alkyl, haloalkyl, halo, alkoxy, or haloalkoxy; and X is C or N.

In additional embodiments, a method of controlling pests comprises applying a 2,4-(substituted aromatic)-1,3-oxazoline compound to at least one seed to control at least one insect species, the 2,4-(substituted aromatic)-1,3-oxazoline compound comprising the following chemical structure: zoline

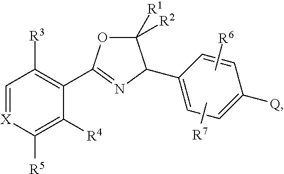

where R¹, R², R³, R⁴, and R⁵ independently comprise hydrogen (H), alkyl, haloalkyl, or halo; Q is selected from aryl, heteroaryl, substituted aryl, and substituted heteroaryl, wherein said substituents are selected from H, alkyl, haloalkyl, halo, alkoxy, and haloalkoxy; R⁶, R⁷, R⁸, and R⁹ independently comprise H, alkyl, haloalkyl, halo, alkoxy, or haloalkoxy; and X is C or N.

In yet additional embodiments, a method of seed treatment comprises contacting at least one seed with at least one of an insecticidally effective amount and a miticidally effective amount of a 2,4-(substituted aromatic)-1,3-oxazoline compound to substantially protect the at least one seed and plant parts developing therefrom from damage effectuated by at least one of insects and mites, the 2,4-(substituted aromatic)-1,3-oxazoline compound comprising the following chemical structure:

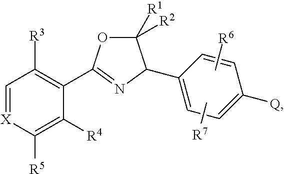

where R¹, R², R³, R⁴, and R⁵ independently comprise hydrogen (H), alkyl, haloalkyl, or halo; Q is selected from aryl, heteroaryl, substituted aryl, and substituted heteroaryl, wherein said substituents are selected from H, alkyl, haloalkyl, halo, alkoxy, and haloalkoxy; R⁶, R⁷, R⁸, and R⁹ independently comprise H, alkyl, haloalkyl, halo, alkoxy, or haloalkoxy; and X is C or N.

### DETAILED DESCRIPTION

Methods of using at least one 2,4-(substituted aromatic)-1,3-oxazoline compound, such as at least one of a 2,6-dihalophenyl oxazoline compound and a 2,6-dihalopyridyl oxazoline compound, as a seed treatment to control at least one pest are disclosed. As used herein, the term “seed treatment” means and includes contacting at least one seed with pesticidally effective amount of the at least one 2,4-(substituted aromatic)-1,3-oxazoline compound. As used herein the term, “pesticidally effective amount” means and includes an amount of active material that causes an adverse effect to the at least one pest, and includes deviations from natural development, killing, regulation, and the like. As used herein, the term “pest” means and includes any species that may damage (e.g., from feeding damage imposed by the pest) one or more seed and/or plant parts. By way of non-limiting example, the at least one pest may be at least one of an insect and a mite. Accordingly, as used herein, the terms “insecticidally effective amount,” and “miticidally effective amount” mean and include an amount of active material that causes an adverse effect to at least one insect and at least one mite, respectively, and includes deviations from natural development, killing, regulation, and the like. As used herein, the term “control,” or grammatical variations thereof, means and includes regulating the number of living pests or regulating the number of viable eggs of the pests. Using the at least one 2,4-(substituted aromatic)-1,3-oxazoline compound as a seed treatment may substantially protect the at least one seed from the at least one pest, and may also protect plant parts developing from the at least one seed. For example, the at least one 2,4-(substituted aromatic)-1,3-oxazoline compound may be translocated during the development of the plant from the at least one seed (e.g., the at least one of the 2,4-(substituted aromatic)-1,3-oxazoline compound may spread from the at least one seed to at least one of the roots and/or the foliage of a developing seedling).

The at least one 2,4-(substituted aromatic)-1,3-oxazoline compound may have the following chemical structure:

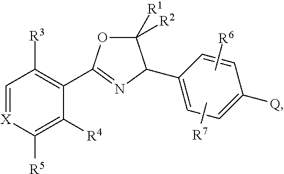

where R¹, R², R³, R⁴, and R⁵ independently represent hydrogen (H), alkyl, haloalkyl, or halo; Q is selected from aryl, heteroaryl, substituted aryl, and substituted heteroaryl, wherein said substituents are selected from H, alkyl, haloalkyl, halo, alkoxy, and haloalkoxy; R⁶, R⁷, R⁸, and R⁹ independently represent H, alkyl, haloalkyl, halo, alkoxy, or haloalkoxy; and X is C or N.

As used herein, the term “alkyl” means and includes a saturated, straight, branched, or cyclic hydrocarbon containing from 1 carbon atom to 6 carbon atoms. Examples include, but are not limited to, methyl, ethyl, propyl, isopropyl, butyl, isobutyl, t-butyl, pentyl, cyclopentyl, isopentyl, neopentyl, hexyl, isohexyl, cyclohexyl, 3-methylpentyl, 2,2-dimethylbutyl, and 2,3-dimethylbutyl.

As used herein, the term “alkoxy” means and includes an alkyl group linked to an oxygen atom.

As used herein, the term “aryl” means and includes a phenyl or substituted phenyl group.

As used herein, the term “halo” means and includes fluoro, chloro, bromo, or iodo.

As used herein, the terms “haloalkyl,” and “haloalkoxy,” respectively mean and include, an alkyl group and an alkoxy group substituted with at least one halo atom.

As used herein, the term “heteroaryl” means and includes an aromatic moiety that includes at least one sulfur, oxygen, or nitrogen in the aromatic ring, and that can be optionally substituted as described above for aryl groups. Examples include, but are not limited to, furyl, pyridyl, pyrimidyl, thienyl, isothiazolyl, imidazolyl, tetrazolyl, pyrazinyl, benzofuranyl, benzothiophenyl, quinolyl, isoquinolyl, benzothienyl, isobenzofuryl, pyrazolyl, indolyl, isoindolyl, benzimidazolyl, purinyl, carbozolyl, oxazolyl, thiazolyl, isothiazolyl, 1,2,4-thiadiazolyl, isooxazolyl, pyrrolyl, pyrazolyl, quinazolinyl, pyridazinyl, pyrazinyl, cinnolinyl, phthalazinyl, quinoxalinyl, xanthinyl, hypoxanthinyl, pteridinyl, 5-azacytidinyl, 5-azauracilyl, triazolopyridinyl, imidazolopyridinyl, pyrrolopyrimidinyl, and pyrazolopyrimidinyl.

The at least one 2,4-(substituted aromatic)-1,3-oxazoline compound of the present disclosure may be produced by conventional techniques and processing equipment, which are not described in detail herein. By way of non-limiting example, the at least one 2,4-(substituted aromatic)-1,3-oxazoline compound may be produced using processes similar to those disclosed in U.S. Pat. Nos. 6,573,286, and 6,924,298, the disclosure of each of which is incorporated by reference herein in its entirety.

A wide variety of pests may be controlled using the at least one 2,4-(substituted aromatic)-1,3-oxazoline compound as a seed treatment. As a non-limiting example, in one or more embodiments, the method of the present disclosure may be used to control one or more members of at least one of Phylum Arthropoda, Phylum Nematoda, Subphylum Chelicerata, Subsphylum Myriapoda, Subphylum Hexapoda, Class Insecta, Class Arachnida, and Class Symphyla. In at least some embodiments, the method of the present disclosure may be used to control one or more members of at least one of Class Insecta and Class Arachnida.

In additional embodiments, the method of the present disclosure may be used to control members of the Order Coleoptera (beetles) including, but not limited to, Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turfgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp., Cerotoma spp. (chrysomelids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysomelids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys fuscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana (chrysomelids), Phynchites spp., Popillia japonica (Japanese beetle), Prostephanus truncates (larger grain borer), Rhizopertha dominica (lesser grain borer), Rhizotrogus spp. (European chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle), and Zabrus tenebioides.

In additional embodiments, the method of the present disclosure may be used to control members of the Order Dermaptera (earwigs).

In additional embodiments, the method of the present disclosure may be used to control members of the Order Dictyoptera (cockroaches) including, but is not limited to, Blattella germanica (German cockroach), Blatta orientalis (oriental cockroach), Parcoblatta pennylvanica, Periplaneta americana (American cockroach), Periplaneta australoasiae (Australian cockroach), Periplaneta brunnea (brown cockroach), Periplaneta fuliginosa (smokybrown cockroach), Pyncoselus suninamensis (Surinam cockroach), and Supella longipalpa (brownbanded cockroach).

In additional embodiments, the method of the present disclosure may be used to control members of the Order Diptera (true flies) including, but is not limited to, Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cochliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (frit fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies), and Tipula spp. (crane flies).

In additional embodiments, the method of the present disclosure may be used to control members of the Order Hemiptera (true bugs) including, but is not limited to, Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea, and Triatoma spp. (bloodsucking conenose bugs/kissing bugs).

In additional embodiments, the method of the present disclosure may be used to control members of the Order Homoptera (aphids, scales, whiteflies, leaflhoppers) including, but is not limited to, Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus spp., Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale), and Zulia entreriana. In at least some embodiments, the method of the present disclosure may be used to control Myzus persicae.

In additional embodiments, the method of the present disclosure may be used to control members of the Order Hymenoptera (ants, wasps, and bees) including, but not limited to, Acromyrrmex spp., Athalia rosae, Atta spp. (leafcutting ants), Camponotus spp. (carpenter ants), Diprion spp. (sawflies), Formica spp. (ants), Iridomyrmex humilis (Argentine ant), Monomorium ssp., Monomorium minumum (little black ant), Monomorium pharaonis (Pharaoh ant), Neodiprion spp. (sawflies), Pogonomyrmex spp. (harvester ants), Polistes spp. (paper wasps), Solenopsis spp. (fire ants), Tapoinoma sessile (odorous house ant), Tetranomorium spp. (pavement ants), Vespula spp. (yellow jackets), and Xylocopa spp. (carpenter bees).

In additional embodiments, the method of the present disclosure may be used to control members of the Order Isoptera (termites) including, but not limited to, Coptotermes spp., Coptotermes curvignathus, Coptotermes frenchii, Coptotermes formosanus (Formosan subterranean termite), Cornitermes spp. (nasute termites), Cryptotermes spp. (drywood termites), Heterotermes spp. (desert subterranean termites), Heterotermes aureus, Kalotermes spp. (drywood termites), Incistitermes spp. (drywood termites), Macrotermes spp. (fungus growing termites), Marginitermes spp. (drywood termites), Microcerotermes spp. (harvester termites), Microtermes obesi, Procornitermes spp., Reticulitermes spp. (subterranean termites), Reticulitermes banyulensis, Reticulitermes grassei, Reticulitermes flavipes (eastern subterranean termite), Reticulitermes hageni, Reticulitermes hesperus (western subterranean termite), Reticulitermes santonensis, Reticulitermes speratus, Reticulitermes tibialis, Reticulitermes virginicus, Schedorhinotermes spp., and Zootermopsis spp. (rotten-wood termites).

In additional embodiments, the method of the present disclosure may be used to control members of the Order Lepidoptera (moths and butterflies) including, but not limited to, Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus cossus (carpenter moth), Crambus spp. (Sod webworms), Cydiafunebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarps, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer), and Zeuzera pyrina (leopard moth). In at least some embodiments, the method of the present disclosure may be used to control Spodoptera exigua.

In additional embodiments, the method of the present disclosure may be used to control members of the Order Mallophaga (chewing lice) including, but not limited to, Bovicola ovis (sheep biting louse), Menacanthus stramineus (chicken body louse), and Menopon gallinea (common hen house).

In additional embodiments, the method of the present disclosure may be used to control members of the Order Orthoptera (grasshoppers, locusts, and crickets) including, but not limited to, Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid), and Valanga nigricorni.

In additional embodiments, the method of the present disclosure may be used to control members of the Order Phthiraptera (sucking lice) including, but not limited to, Haematopinus spp. (cattle and hog lice), Linognathus ovillus (sheep louse), Pediculus humanus capitis (human body louse), Pediculus humanus humanus (human body lice), and Pthirus pubis (crab louse).

In additional embodiments, the method of the present disclosure may be used to control members of the Order Siphonaptera (fleas) including, but not limited to, Ctenocephalides canis (dog flea), Ctenocephalides felis (cat flea), and Pulex irritans (human flea).

In additional embodiments, the method of the present disclosure may be used to control members of the Order Thysanoptera (thrips) including, but not limited to, Frankliniella fusca (tobacco thrips), Frankliniella occidentalis (western flower thrips), Frankliniella shultzei, Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis, and Thrips spp.

In additional embodiments, the method of the present disclosure may be used to control members of the Order Thysanura (bristletails) including, but not limited to, Lepisma spp. (silverfish) and Thermobia spp. (firebrats).

In additional embodiments, the method of the present disclosure may be used to control members of the Order Acari (mites and ticks) including, but not limited to, Acarapsis woodi (tracheal mite of honeybees), Acarus spp. (food mites), Acarus siro (grain mite), Aceria mangiferae (mango bud mite), Aculops spp., Aculops lycopersici (tomato russet mite), Aculops pelekasi, Aculus pelekassi, Aculus schlechtendali (apple rust mite), Amblyomma americanum (lone star tick), Boophilus spp. (ticks), Brevipalpus obovatus (privet mite), Brevipalpus phoenicis (red and black flat mite), Demodex spp. (mange mites), Dermacentor spp. (hard ticks), Dermacentor variabilis (american dog tick), Dermatophagoides pteronyssinus (house dust mite), Eotetranycus spp., Eotetranychus carpini (yellow spider mite), Epitimerus spp., Eriophyes spp., Ixodes spp. (ticks), Metatetranycus spp., Notoedres cati, Oligonychus spp., Oligonychus coffee, Oligonychus ilicus (southern red mite), Panonychus spp., Panonychus citri (citrus red mite), Panonychus ulmi (European red mite), Phyllocoptruta oleivora (citrus rust mite), Polyphagotarsonemun latus (broad mite), Rhipicephalus sanguineus (brown dog tick), Rhizoglyphus spp. (bulb mites), Sarcoptes scabiei (itch mite), Tegolophus perseaflorae, Tetranychus spp., Tetranychus urticae (twospotted spider mite), and Varroa destructor (honey bee mite).

In additional embodiments, the method of the present disclosure may be used to control members of the Order Nematoda (nematodes) including, but not limited to, Aphelenchoides spp. (bud and leaf& pine wood nematodes), Belonolaimus spp. (sting nematodes), Criconemella spp. (ring nematodes), Dirofilaria immitis (dog heartwom), Ditylenchus spp. (stem and bulb nematodes), Heterodera spp. (cyst nematodes), Heterodera zeae (corn cyst nematode), Hirschmanniella spp. (root nematodes), Hoplolaimus spp. (lance nematodes), Meloidogyne spp. (root knot nematodes), Meloidogyne incognita (root knot nematode), Onchocerca volvulus (hook-tail worm), Pratylenchus spp. (lesion nematodes), Radopholus spp. (burrowing nematodes), and Rotylenchus reniformis (kidney-shaped nematode).

In at least some embodiments, the method of the present disclosure may be used to control at least one insect in one or more of the Orders Lepidoptera, Coleoptera, Homoptera, Hemiptera, Thysanoptera, Isoptera, Orthoptera, Diptera, Hymenoptera, and Siphonaptera, and at least one mite in the Order Acari.

The at least one seed may be any type of seed. The at least one seed may, for example, be a seed produced by a higher plant, such as a dicotyledonous plant or a monocotyledonous plant. In at least some embodiments, the at least one seed may produced by a consumable plant, such as a commercial crop plant. As a non-limiting example, the at least one seed may be produced from a plant in at least one of the following genuses: Allium, Antirrhinum, Arachis, Asparagus, Avena, Begonia, Beta, Betholettia, Brassica, Capsicum, Carthamus, Chrysanthemum, Cicer, Cichorium, Citrillus, Coriandrum, Cocus, Cucumis, Cucurbita, Cyclamen, Daucus, Dianthus, Elaeis, Gazania, Gerbera, Glycine, Gossypium, Helianthus, Hordeum, Impatiens, Ipomoea, Lactuca, Lavatera, Lens, Lobelia, Lolium, Medicago, Nicotiana, Olea, Oryza, Pelargonium, Petunia, Phaseolus, Pisum, Phlox, Poa, Primula, Raphanus, Ricinus, Salvia, Secale, Simmondsia, Solanum, Sorghum, Spinacia, Tageta, Trifolium, Triticale, Triticum, Valerianella, Verbena, Viciam, Vinca, Viola, Zea, and Zinnia. The at least one seed may be produced from any genotype and cultivar of a plant, the selection of which is within the discretion of the practitioner. The at least one seed may also be produced from hybrids and genetically modified versions of the foregoing plants.

The at least one 2,4-(substituted aromatic)-1,3-oxazoline compound may be applied to the at least one seed by any of a variety of conventional techniques (e.g., spraying, coating, dusting, and soaking). Suitable application processes include, for example, those listed in P. Kosters et. al., “Seed Treatment: Progress and Prospects,” 1994 BCPC Mongraph No. 57. An pesticidally effective amount of the at least one 2,4-(substituted aromatic)-1,3-oxazoline compound may be applied to the at least one seed at any time from the harvest of the at least one seed from an associated plant to the sowing of the at least one seed. The at least one 2,4-(substituted aromatic)-1,3-oxazoline compound may be applied to the at least one seed before the planting of the at least one seed, during the planting of the at least one seed, or a combination thereof. If the at least one 2,4-(substituted aromatic)-1,3-oxazoline compound is applied before the planting of the at least one seed, the seed treatment may occur at any time within a range from substantially immediately before planting to about 12 months before planting. Multiple applications of the at least one 2,4-(substituted aromatic)-1,3-oxazoline compound may be applied to the at least one seed.

One of ordinary skill in the art will understand, while the present disclosure describes using the at least one 2,4-(substituted aromatic)-1,3-oxazoline compound as a seed treatment, the at least one 2,4-(substituted aromatic)-1,3-oxazoline compound may also be applied other areas encompassed within the locus of at least one pest. As used herein, the term “locus” means and includes an environment in which the at least one of pest lives or where eggs of the at least one pest are present, such as the air surrounding the at least one pest, the food of the at least one pest, or objects or materials the at least one pest contacts. By way of non-limiting example, the locus may include at least one of various plant parts (e.g., foliage, stem, roots, etc.), soil surrounding a plant, animals, and humans. The 2,4-(substituted aromatic)-1,3-oxazoline compound may also be applied to other objects or materials in need of protection from the at least one pest, such as textiles, paper, other foodstuffs, or buildings.

The at least one 2,4-(substituted aromatic)-1,3-oxazoline compound may be applied to (e.g., dusted on) the at least one seed without further treatment, or a formulation including the at least one 2,4-(substituted aromatic)-1,3-oxazoline compound and at least one inert carrier may be applied to the at least one seed. Utilizing a formulation to treat the at least one seed may, for example, enhance one or more of ease of application, handling, storage, and maximum pesticidal activity. If a formulation is used, the at least one inert carrier may be a solid carrier (e.g., talc, pyrophyllite clay, silica, attapulgus clay, kaolin clay, kieselguhr, chalk, diatomaceous earth, lime, calcium carbonate, bentonite clay, Fuller's earth, cotton seed hulls, wheat flour, soybean flour, pumice, wood flour, walnut shell flour, lignin, combinations thereof, and the like), or may be a liquid carrier (e.g., water, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methanol, ethanol, isopropanol, amyl alcohol, ethylene glycol, propylene glycol, glycerine, combinations thereof, and the like). In addition, if a formulation is used, the at least one 2,4-(substituted aromatic)-1,3-oxazoline compound and the at least one inert carrier may be applied in the form of any of a variety of conventional formulation types including, but not limited to, a wettable powder, an emulsifiable concentrate, a suspension concentrate, an dilute emulation (e.g., aqueous emulation), an dilute suspension (e.g., aqueous suspension), a directly sprayable or dilutable solution, a coatable paste, and a dust. The aforementioned formulation types can be prepared according to procedures that are conventional in the agricultural chemical art.

If, for example, the formulation is applied to the at least one seed as a wettable powder, the wettable powder may comprise a mixture the at least one 2,4-(substituted aromatic)-1,3-oxazoline compound and at least one solid carrier. The mixture may be compacted to form water-dispersible granules. The at least one solid carrier and the at least one surfactant may be blended with the at least one 2,4-(substituted aromatic)-1,3-oxazoline compound and milled. A concentration of the at least one 2,4-(substituted aromatic)-1,3-oxazoline compound in the wettable powder may be within a range of from about 10 percent by weight to about 90 percent by weight, such as from about 25 percent by weight to about 75 percent by weight. The wettable powder may, optionally, include at least one surfactant, such as a sulfonated lignin, a condensed naphthalenesulfonate, a naphthalenesulfonate, an alkylbenzenesulfonate, an alkyl sulfate, and a non-ionic surfactant (e.g., anethylene oxide adduct of an alkyl phenol). If present, a concentration at least one surfactant in the wettable powder may be within a range of from about 0.5 percent by weight to about 10 percent by weight. The at least one surfactant may aid in at least one of the formation and the stabilization of the wettable powder.

If, for example, the formulation is applied to the at least one seed as an emulsifiable concentrate, the emulsifiable concentrate may include the at least one 2,4-(substituted aromatic)-1,3-oxazoline compound, and at least one liquid carrier. The at least one 2,4-(substituted aromatic)-1,3-oxazoline compound may be substantially dissolved in the at least one liquid carrier. The emulsifiable concentrate may, optionally, include at least one emulsifier at a concentration within a range of from about 1 percent by weight to about 30 percent by weight. As used herein, the term “emulsifier” means and includes a material that stabilizes a suspension of droplets of one liquid phase in another liquid phase. The at least one emulsifier may be non-ionic, anionic, cationic, or a combination thereof. Non-limiting examples of non-ionic emulsifiers include polyalkylene glycol ethers and condensation products of alkyl and aryl phenols, aliphatic alcohols, aliphatic amines or fatty acids with ethylene oxide, propylene oxides such as the ethoxylated alkyl phenols, and carboxylic esters solubilized with the polyol or polyoxyalkylene. Non-limiting examples of anionic emulsifiers include oil-soluble salts (e.g., calcium) of alkylaryl sulphonic acids, oil-soluble salts, sulfated polyglycol ethers, and salts of phosphated polyglycol ether. Non-limiting examples of cationic emulsifiers include quaternary ammonium compounds, and fatty amine salts. The emulsifiable concentrate may also contain other compatible additives, such as plant growth regulators and other biologically active compounds used in agriculture. A concentration of the at least one 2,4-(substituted aromatic)-1,3-oxazoline compound in the emulsifiable concentrate may, for example, be within a range of from about 10 percent by weight to about 50 percent by weight. In one or more embodiments, the emulsifiable concentrate may be diluted with water and oil to form spray mixtures in the form of oil-in-water emulsions.

If, for example, the formulation is applied to the at least one seed as an aqueous suspension, the aqueous suspension may include the at least one 2,4-(substituted aromatic)-1,3-oxazoline compound dispersed in an aqueous liquid carrier (e.g., water). A concentration of the at least one 2,4-(substituted aromatic)-1,3-oxazoline compound in the aqueous suspension may be within a range from about 5 to about 50 weight percent. The aqueous suspension may be prepared by finely grinding the at least one 2,4-(substituted aromatic)-1,3-oxazoline compound, and mixing the at least one 2,4-(substituted aromatic)-1,3-oxazoline compound into the aqueous liquid carrier. The aqueous suspension may, optionally, include at least one surfactant that may aid in the formation and/or the stabilization of the aqueous suspension. Other materials, such as inorganic salts and synthetic or natural gums, may be added to increase one or more of the density and the viscosity of the aqueous suspension.

If, for example, the formulation is applied to the at least one seed as an aqueous emulsion, the aqueous emulsion may include the at least one 2,4-(substituted aromatic)-1,3-oxazoline compound emulsified in an aqueous liquid carrier. A concentration of the at least one 2,4-(substituted aromatic)-1,3-oxazoline compound in the aqueous emulsion may be within a range from about 5 to about 50 weight percent. The at least one 2,4-(substituted aromatic)-1,3-oxazoline compound can dissolved in a water-immiscible solvent before preparation of the aqueous emulsion. Non-limiting examples of suitable water-immiscible solvents include aromatic hydrocarbons derived from benzene, such as toluene, xylenes, other alkylated benzenes and the like, and naphthalene derivatives, aliphatic hydrocarbons such as hexane, octane, cyclohexane, and the like, mineral oils from the aliphatic or isoparaffinic series, and mixtures of aromatic and aliphatic hydrocarbons; halogenated aromatic or aliphatic hydrocarbons; vegetable, seed or animal oils such as soybean oil, rape seed oil, olive oil, castor oil, sunflower seed oil, coconut oil, corn oil, cotton seed oil, linseed oil, palm oil, peanut oil, safflower oil, sesame oil, tung oil and the like, and C₁-C₆ mono-esters derived from vegetable, seed or animal oils; C₁-C₆ dialkyl amides of C₆-C₂₀ saturated and unsaturated aliphatic carboxylic acids, such as, N—N-dimethyl alkyl amide; C₁-C₁₂ esters of aromatic carboxylic acids and dicarboxylic acids and C₁-C₁₂ esters of aliphatic and cyclo-aliphatic carboxylic acids; C₄-C₁₂ polyesters of dihydric, trihydric, or other lower polyalcohols such as, propylene glycol dioleate, di-octyl succinate, di-butyl adipate, di-octyl phthalate and the like. The aqueous emulsion may be prepared by emulsifying the at least one 2,4-(substituted aromatic)-1,3-oxazoline compound or a water-immiscible solution thereof into the aqueous liquid carrier. The aqueous emulsion may, optionally, include at least one surfactant that may aid in the formation and/or the stabilization of the aqueous emulsion.

If, for example, the formulation is applied to the at least one seed as a directly sprayable or diluable solution, the directly sprayable or diluable solution may include the at least one 2,4-(substituted aromatic)-1,3-oxazoline compound dispersed in at least one organic solvent (e.g., toluene, xylenes, other alkylated benzenes and the like, and naphthalene derivatives, aliphatic hydrocarbons such as hexane, octane, cyclohexane, and the like, mineral oils from the aliphatic or isoparaffinic series, and mixtures of aromatic and aliphatic hydrocarbons; halogenated aromatic or aliphatic hydrocarbons; vegetable, seed or animal oils such as soybean oil, rape seed oil, olive oil, castor oil, sunflower seed oil, coconut oil, corn oil, cotton seed oil, linseed oil, palm oil, peanut oil, safflower oil, sesame oil, tung oil and the like, and C₁-C₆ mono-esters derived from vegetable, seed or animal oils; C₁-C₆ dialkyl amides of C₆-C₂₀ saturated and unsaturated aliphatic carboxylic acids, such as, N—N-dimethyl alkyl amide; C₁-C₁₂ esters of aromatic carboxylic acids and dicarboxylic acids and C₁-C₁₂ esters of aliphatic and cyclo-aliphatic carboxylic acids; C₄-C₁₂ polyesters of dihydric, trihydric, or other lower polyalcohols such as, propylene glycol dioleate, di-octyl succinate, di-butyl adipate, di-octyl phthalate and the like).

If, for example, the formulation is applied to the at least one seed as an granular dust, the granular formulation may include the at least one 2,4-(substituted aromatic)-1,3-oxazoline compound dispersed in at least one solid carrier (e.g., kaolin clay, ground volcanic rock, etc.). The at least one solid carrier may be provided as a powder. A concentration of the at least one 2,4-(substituted aromatic)-1,3-oxazoline compound in the dust may be within a range from about 1 weight percent to about 10 weight percent.

The at least one 2,4-(substituted aromatic)-1,3-oxazoline compound, or the formulation including the at least one 2,4-(substituted aromatic)-1,3-oxazoline compound, may, optionally, be applied to the at least one seed concurrently (i.e., simultaneously) with or consecutively with (e.g., before or after) at least one additional material. The at least one additional material may be a material or compound that has a desired utility and that does not substantially interfere with a desired pesticidal activity (e.g., a desired insecticidal activity and/or a desired miticidal activity) of the at least one 2,4-(substituted aromatic)-1,3-oxazoline compound. Whether or not the at least one additional material substantially interferes with the desired pesticidal activity of the at least one 2,4-(substituted aromatic)-1,3-oxazoline compound can be really determined by those of skill in the art using standard test formats including, but not limited to, those involving direct comparisons of the efficacy of the at least one 2,4-(substituted aromatic)-1,3-oxazoline compound of the present disclosure with and without the at least one additional material. By way of non-limiting example, the at least one additional material may be one or more of at least one adjuvant material and at least one additional pesticide.

The at least one adjuvant material, if used, may be a conventional adjuvant used in the agricultural sciences art including, but not limited to, a wetting agent, a dispersant, a binder, a penetrant, a fertilizer, a growth regulator, a buffer, a dye, a sequestering agent, a drift reduction agent, a compatibility agent, a viscosity regulator, an anti-foam agent, a cleaning agent, a surfactant, an emulsifier, combinations thereof, and the like. Suitable adjuvant materials are well known in the agricultural sciences art (e.g., see “Chemistry and Technology of Agrochemical Formulations” edited by D. A. Knowles, copyright 1998 by Kluwer Academic Publishers; also see “Insecticides in Agriculture and Environment—Retrospects and Prospects” by A. S. Perry, I. Yamamoto, I. Ishaaya, and R. Perry, copyright 1998 by Springer-Verlag). In at least some embodiments, the at least one adjuvant material includes at least one binder (e.g., a polyacrylate, a polymethacrylate, a polybutene, a polyisobutylene, a polyether, a polyethyleneamine, a polyethyleneamide, a polyethyleneimine, a polystyrene, a polyurethane, a polyvinylalcohol, a polyvinylpyrrolidone, polyvinylacetate, copolymers derived from such polymers, and combinations thereof) that may enhance the adhesion of the at least one 2,4-(substituted aromatic)-1,3-oxazoline compound to the at least one seed.

As used herein, the term “pesticide,” means and includes an active material that kills, regulates, or otherwise adversely affects the growth of pests (e.g., insects, mites, ticks, nematodes, bacteria, fungi, diseases, and plants). By way of non-limiting example, if used, the at least one additional pesticide may be at least one of an insecticide, an acaricide (e.g., miticide, ixodicide, scabicide, archnicide, etc.), a nematocide, a bactericide, a biocide, an anthropodicide, a molluscide, a fungicide, and a herbicide. In one or more embodiments, the at least one additional pesticide may be used to control at least one of insects, mites, ticks, nematodes, bacteria, fungi, diseases, and plants (e.g., weeds). The at least one additional pesticide may be, for example, at least one of an insecticide, a fungicide, and a herbicide, each of which is described in further detail below. The at least one 2,4-(substituted aromatic)-1,3-oxazoline compound and the at least one additional pesticide may, for example, be present in a weight ratio of from about 1:100 to about 100:1.

If utilized, the insecticide may be used for the same pesticidal activity as the at least one 2,4-(substituted aromatic)-1,3-oxazoline compound (e.g., to control insects of a particular Order, Family, Genus, Species, etc.), or may be used for a different pesticidal activity (e.g., to control insects of a different Order, Family, Genus, Species, etc.). As used herein, the term “insecticide,” means and includes an active material that kills, regulates, or otherwise adversely affects the growth of insects. Non-limiting examples of suitable insecticides that may be used as the at least one additional pesticide include: antibiotic insecticides, such as allosamidin and thuringiensin; macrocyclic lactone insecticides, such as spinosad, spinetoram, and other spinosyns including the 21-butenyl spinosyns and their derivatives; avermectin insecticides, such as abamectin, doramectin, emamectin, eprinomectin, ivermectin and selamectin; milbemycin insecticides, such as lepimectin, milbemectin, milbemycin oxime and moxidectin; arsenical insecticides, such as calcium arsenate, copper acetoarsenite, copper arsenate, lead arsenate, potassium arsenite and sodium arsenite; biological insecticides such as Bacillus popilliae, B. sphaericus, B. thuringiensis subsp. aizawai, B. thuringiensis subsp. kurstaki, B. thuringiensis subsp. tenebrionis, Beauveria bassiana, Cydia pomonella granulosis virus, Douglas fir tussock moth NPV, gypsy moth NPV, Helicoverpa zea NPV, Indian meal moth granulosis virus, Metarhizium anisopliae, Nosema locustae, Paecilomyces fumosoroseus, P. lilacinus, Photorhabdus luminescens, Spodoptera exigua NPV, trypsin modulating oostatic factor, Xenorhabdus nematophilus, and X. bovienii, plant incorporated protectant insecticides such as Cry1Ab, Cry1Ac, Cry1F, Cry1A.105, Cry2Ab2, Cry3A, mir Cry3A, Cry3Bb1, Cry34, Cry35, and VIP3A; botanical insecticides, such as anabasine, azadirachtin, d-limonene, nicotine, pyrethrins, cinerins, cinerin I, cinerin II, jasmolin I, jasmolin II, pyrethrin I, pyrethrin II, quassia, rotenone, ryania and sabadilla; carbamate insecticides such as bendiocarb and carbaryl; benzofuranyl methylcarbamate insecticides, such as benfuracarb, carbofuran, carbosulfan, decarbofuran and furathiocarb; dimethylcarbamate insecticides dimitan, dimetilan, hyquincarb and pirimicarb; oxime carbamate insecticides, such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides, such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dinitrophenol insecticides, such as dinex, dinoprop, dinosam and DNOC; fluorine insecticides, such as barium hexafluorosilicate, cryolite, sodium fluoride, sodium hexafluorosilicate and sulfluramid; formamidine insecticides, such as amitraz, chlordimeform, formetanate and formparanate; fumigant insecticides, such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides, such as borax, calcium polysulfide, copper oleate, mercurous chloride, potassium thiocyanate and sodium thiocyanate; chitin synthesis inhibitors such as bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron and triflumuron; juvenile hormone mimics, such as epofenonane, fenoxycarb, hydroprene, kinoprene, methoprene, pyriproxyfen and triprene; juvenile hormones such as juvenile hormone I, juvenile hormone II and juvenile hormone III; moulting hormone agonists, such as chromafenozide, halofenozide, methoxyfenozide and tebufenozide; moulting hormones such as α-ecdysone and ecdysterone; moulting inhibitors, such as diofenolan; precocenes, such as precocene I, precocene II and precocene III; unclassified insect growth regulators, such as dicyclanil; nereistoxin analogue insecticides, such as bensultap, cartap, thiocyclam and thiosultap; nicotinoid insecticides, such as flonicamid; nitroguanidine insecticides, such as clothianidin, dinotefuran, imidacloprid and thiamethoxam; aminofuranone neonicotinoids such as BYI-02960; semisynthetic fermentation products such as cypropen; nitromethylene insecticides, such as nitenpyram and nithiazine; pyridylmethylamine insecticides, such as acetamiprid, imidacloprid, nitenpyram and thiacloprid; organochlorine insecticides, such as bromo-DDT, camphechlor, DDT, pp′-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, endrin, HEOD, heptachlor, HHDN, isobenzan, isodrin, kelevan and mirex; organophosphate insecticides, such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides, such as dioxabenzofos, fosmethilan and phenthoate; aliphatic organothiophosphate insecticides, such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos and thiometon; aliphatic amide organothiophosphate insecticides, such as amidithion, cyanthoate, dimethoate, ethoate-methyl, formothion, mecarbam, omethoate, prothoate, sophamide and vamidothion; oxime organothiophosphate insecticides, such as chlorphoxim, phoxim and phoxim-methyl; heterocyclic organothiophosphate insecticides, such as azamethiphos, coumaphos, coumithoate, dioxathion, endothion, menazon, morphothion, phosalone, pyraclofos, pyridaphenthion and quinothion; benzothiopyran organothiophosphate insecticides, such as dithicrofos and thicrofos; benzotriazine organothiophosphate insecticides such as azinphos-ethyl and azinphos-methyl; isoindole organothiophosphate insecticides, such as dialifos and phosmet; isoxazole organothiophosphate insecticides, such as isoxathion and zolaprofos; pyrazolopyrimidine organothiophosphate insecticides, such as chlorprazophos and pyrazophos; pyridine organothiophosphate insecticides, such as chlorpyrifos and chlorpyrifos-methyl; pyrimidine organothiophosphate insecticides, such as butathiofos, diazinon, etrimfos, lirimfos, pirimiphos-ethyl, pirimiphos-methyl, primidophos, pyrimitate and tebupirimfos; quinoxaline organothiophosphate insecticides, such as quinalphos and quinalphos-methyl; thiadiazole organothiophosphate insecticides, such as athidathion, lythidathion, methidathion and prothidathion; triazole organothiophosphate insecticides, such as isazofos and triazophos; phenyl organothiophosphate insecticides, such as azothoate, bromophos, bromophos-ethyl, carbophenothion, chlorthiophos, cyanophos, cythioate, dicapthon, dichlofenthion, etaphos, famphur, fenchlorphos, fenitrothion fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3 and trifenofos; phosphonate insecticides, such as butonate and trichlorfon; phosphonothioate insecticides, such as mecarphon; phenyl ethylphosphonothioate insecticides, such as fonofos and trichloronat; phenyl phenylphosphonothioate insecticides, such as cyanofenphos, EPN and leptophos; phosphoramidate insecticides such as crufomate, fenamiphos, fosthietan, mephosfolan, phosfolan and pirimetaphos; phosphoramidothioate insecticides such as acephate, isocarbophos, isofenphos, methamidophos and propetamphos; phosphorodiamide insecticides, such as dimefox, mazidox, mipafox and schradan; oxadiazine insecticides, such as indoxacarb; phthalimide insecticides, such as dialifos, phosmet and tetramethrin; pyrazole insecticides, such as acetoprole, ethiprole, fipronil, pyrafluprole, pyriprole, tebufenpyrad, tolfenpyrad and vaniliprole; pyrethroid ester insecticides, such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin and transfluthrin; pyrethroid ether insecticides, such as etofenprox, flufenprox, halfenprox, protrifenbute and silafluofen; pyrimidinamine insecticides, such as flufenerim and pyrimidifen; pyrrole insecticides, such as chlorfenapyr; tetronic acid insecticides, such as spirodiclofen, spiromesifen and spirotetramat; thiourea insecticides such as diafenthiuron; urea insecticides, such as flucofuron and sulcofuron; and unclassified insecticides, such as AKD-3088, closantel, crotamiton, cyflumetofen, EXD, fenazaflor, fenazaquin, fenoxacrim, fenpyroximate, FKI-1033, flubendiamide, cyazypyr (cyantraniliprole), hydramethylnon, IKI-2002, isoprothiolane, malonoben, metaflumizone, metoxadiazone, nifluridide, NNI-9850, NNI-0101 (pyrifluquinazon), pymetrozine, pyridaben, pyridalyl, Qcide, rafoxanide, rynaxypyr (chlorantraniliprole), SYJ-159, sulfoxaflor, triarathene, and triazamate, and any combinations thereof.

As used herein, the term “fungicide,” means and includes an active material that kills, controls, or otherwise adversely affects the growth of fungi or fungal spores. Non-limiting examples of suitable fungicides that may be used as the at least one additional pesticide include 2-(thiocyanatomethylthio)-benzothiazole, 2-phenylphenol, 8-hydroxyquinoline sulfate, Ampelomyces, quisqualis, azaconazole, azoxystrobin, Bacillus subtilis, benalaxyl, benomyl, benthiavalicarb-isopropyl, benzylaminobenzene-sulfonate (BABS) salt, bicarbonates, biphenyl, bismerthiazol, bitertanol, blasticidin-S, borax, Bordeaux mixture, boscalid, bromuconazole, bupirimate, calcium polysulfide, captafol, captan, carbendazim, carboxin, carpropamid, carvone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenarnid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquat ion, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fentin, fentin acetate, fentin hydroxide, ferbam, ferimzone, fluazinam, fludioxonil, flumorph, fluopicolide, fluoroimide, fluoxastrobin, fluquinconazole, flusilazole, flusulfamide, flutolanil, flutriafol, folpet, formaldehyde, fosetyl, fosetyl-aluminium, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), ipconazole, iprobenfos, iprodione, iprovalicarb, isoprothiolane, kasugamycin, kasugamycin hydrochloride hydrate, kresoxim-methyl, mancopper, mancozeb, maneb, mepanipyrim, mepronil, mercuric chloride, mercuric oxide, mercurous chloride, metalaxyl, mefenoxam, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrazophos, pyributicarb, pyrifenox, pyrimethanil, pyroquilon, quinoclamine, quinoxyfen, quintozene, Reynoutria sachalinensis extract, silthiofam, simeconazole, sodium 2-phenylphenoxide, sodium bicarbonate, sodium pentachlorophenoxide, spiroxamine, sulfur, SYP-Z071, tar oils, tebuconazole, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triticonazole, validamycin, vinclozolin, zineb, ziram, zoxamide, Candida oleophila, Fusarium oxysporum, Gliocladium spp., Phlebiopsis gigantean, Streptomyces griseoviridis, Trichoderma spp.,
(RS)—N-(3,5-dichlorophenyl)-2-(methoxymethyl)-succinimide, 1,2-dichloropropane, 1,3-dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme: ampropylfos, anilazine, azithiram, barium polysulfide, Bayer 32394, benodanil, benquinox, bentaluron, benzamacril; benzamacril-isobutyl, benzamorf, binapacryl, bis(methylmercury) sulfate, bis(tributyltin) oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, cufraneb, cupric hydrazinium sulfate, cuprobam, cyclafuramid, cypendazole, cyprofuram, decafentin, dichlone, dichlozoline, diclobutrazol, dimethirimol, dinocton, dinosulfon, dinoterbon, dipyrithione, ditalimfos, dodicin, drazoxolon, EBP, ESBP, etaconazole, etem, ethirim, fenaminosulf, fenapanil, fenitropan, fluotrimazole, furcarbanil, furconazole, furconazole-cis, furmecyclox, furophanate, glyodine, griseofulvin, halacrinate, Hercules 3944, hexylthiofos, ICIA0858, isopamphos, isovaledione, mebenil, mecarbinzid, metazoxolon, methfuroxam, methylmercury dicyandiamide, metsulfovax, milneb, mucochloric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, phenylmercury dimethyldithiocarbamate, phenylmercury nitrate, phosdiphen, prothiocarb; prothiocarb hydrochloride, pyracarbolid, pyridinitril, pyroxychlor, pyroxyfur, quinacetol; quinacetol sulfate, quinazamid, quinconazole, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, urbacid, XRD-563, and zarilamid, and any combinations thereof.

As used herein, the term “herbicide,” means and includes an active material that kills, controls, or otherwise adversely affects the growth of plants. Non-limiting examples of suitable herbicides that may be used as the at least one additional pesticide include amide herbicides such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid and tebutam; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides, such as benzoylprop, flampropand flamprop-M; chloroacetanilide herbicides, such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor and xylachlor; sulfonanilide herbicides, such as benzofluor, perfluidone, pyrimisulfan and profluazol; sulfonamide herbicides, such as asulam, carbasulam, fenasulam and oryzalin; antibiotic herbicides, such as bilanafos; benzoic acid herbicides, such as chloramben, dicamba, 2,3,6-TBA and tricamba; pyrimidinyloxybenzoic acid herbicides, such as bispyribac and pyriminobac; pyrimidinylthiobenzoic acid herbicides, such as pyrithiobac; phthalic acid herbicides, such as chlorthal; picolinic acid herbicides such as aminopyralid, clopyralid and picloram; quinolinecarboxylic acid herbicides, such as quinclorac and quinmerac; arsenical herbicides, such as cacodylic acid, CMA, DSMA, hexaflurate, MAA, MAMA, MSMA, potassium arsenite and sodium arsenite; benzoylcyclohexanedione herbicides, such as mesotrione, sulcotrione, tefuryltrione and tembotrione; benzofuranyl alkylsulfonate herbicides, such as benfuresate and ethofumesate; carbamate herbicides, such as asulam, carboxazole chlorprocarb, dichlormate, fenasulam, karbutilate and terbucarb; carbanilate herbicides, such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides, such as alloxydim, butroxydim, clethodim, cloproxydim, cycloxydim, profoxydim, sethoxydim, tepraloxydim and tralkoxydim; cyclopropylisoxazole herbicides, such as isoxachlortole and isoxaflutole; dicarboximide herbicides, such as benzfendizone, cinidon-ethyl, flumezin, flumiclorac, flumioxazin and flumipropyn; dinitroaniline herbicides, such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides, such as dinofenate, dinoprop, dinosam, dinoseb, dinoterb, DNOC, etinofen and medinoterb; diphenyl ether herbicides, such as ethoxyfen; nitrophenyl ether herbicides, such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides, such as dazomet and metam; halogenated aliphatic herbicides, such as alorac, chloropon, dalapon, flupropanate, hexachloroacetone, iodomethane, methyl bromide, monochloroacetic acid, SMA and TCA; imidazolinone herbicides, such as imazamethabenz, imazamox, imazapic, imazapyr, imazaquin and imazethapyr; inorganic herbicides, such as ammonium sulfamate, borax, calcium chlorate, copper sulfate, ferrous sulfate, potassium azide, potassium cyanate, sodium azide, sodium chlorate and sulfuric acid; nitrile herbicides, such as bromobonil, bromoxynil, chloroxynil, dichlobenil, iodobonil, ioxynil and pyraclonil; organophosphorus herbicides, such as amiprofos-methyl, anilofos, bensulide, bilanafos, butamifos, 2,4-DEP, DMPA, EBEP, fosamine, glufosinate, glyphosate and piperophos; phenoxy herbicides, such as bromofenoxim, clomeprop, 2,4-DEB, 2,4-DEP, difenopenten, disul, erbon, etnipromid, fenteracol and trifopsime; phenoxyacetic herbicides, such as 4-CPA, 2,4-D, 3,4-DA, MCPA, MCPA-thioethyl and 2,4,5-T; phenoxybutyric herbicides, such as 4-CPB, 2,4-DB, 3,4-DB, MCPB and 2,4,5-TB; phenoxypropionic herbicides, such as cloprop, 4-CPP, dichlorprop, dichlorprop-P, 3,4-DP, fenoprop, mecopropand mecoprop-P; aryloxyphenoxypropionic herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides, such as dinitramine and prodiamine; pyrazolyl herbicides, such as benzofenap, pyrazolynate, pyrasulfotole, pyrazoxyfen, pyroxasulfone and topramezone; pyrazolylphenyl herbicides, such as fluazolate and pyraflufen; pyridazine herbicides, such as credazine, pyridafol and pyridate; pyridazinone herbicides, such as brompyrazon, chloridazon, dimidazon, flufenpyr, metflurazon, norflurazon, oxapyrazon and pydanon; pyridine herbicides such as aminopyralid, cliodinate, clopyralid, dithiopyr, fluoroxypyr, haloxydine, picloram, picolinafen, pyriclor, thiazopyr and triclopyr; pyrimidinediamine herbicides, such as iprymidam and tioclorim; quaternary ammonium herbicides, such as cyperquat, diethamquat, difenzoquat, diquat, morfamquat and paraquat; thiocarbamate herbicides, such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vemolate; thiocarbonate herbicides, such as dimexano, EXD and proxan; thiourea herbicides such as methiuron; triazine herbicides, such as dipropetryn, triaziflam and trihydroxytriazine; chlorotriazine herbicides, such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides, such as atraton, methometon, prometon, secbumeton, simeton and terbumeton; methylthiotriazine herbicides, such as ametryn, aziprotryne, cyanatryn, desmetryn, dimethametryn, methoprotryne, prometryn, simetryn and terbutryn; triazinone herbicides, such as ametridione, amibuzin, hexazinone, isomethiozin, metamitron and metribuzin; triazole herbicides, such as amitrole, cafenstrole, epronaz and flupoxam; triazolone herbicides, such as amicarbazone, bencarbazone, carfentrazone, flucarbazone, propoxycarbazone, sulfentrazone and thiencarbazone-methyl; triazolopyrimidine herbicides, such as cloransulam, diclosulam, florasulam, flumetsulam, metosulam, penoxsulam and pyroxsulam; uracil herbicides, such as butafenacil, bromacil, flupropacil, isocil, lenacil and terbacil; 3-phenyluracils; urea herbicides, such as benzthiazuron, cumyluron, cycluron, dichloralurea, diflufenzopyr, isonoruron, isouron, methabenzthiazuron, monisouron and noruron; phenylurea herbicides, such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron and thidiazuron; pyrimidinylsulfonylurea herbicides, such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron and trifloxysulfuron; triazinylsulfonylurea herbicides, such as chlorsulfuron, cinosulfuron, ethametsulfuron, iodosulfuron, metsulfuron, prosulfuron, thifensulfuron, triasulfuron, tribenuron, triflusulfuron and tritosulfuron; thiadiazolylurea herbicides, such as buthiuron, ethidimuron, tebuthiuron, thiazafluoron and thidiazuron; and unclassified herbicides such as acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, fluorochloridone, flurtamone, fluthiacet, indanofan, methazole, methyl isothiocyanate, nipyraclofen, OCH, oxadiargyl, oxadiazon, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan, and tritac.

The use of the at least one 2,4-(substituted aromatic)-1,3-oxazoline compound as a seed treatment to control pests, such as insects and mites, advantageously mitigates resistance development to current pesticides (e.g., insecticides and miticides) used as seed treatments to control pests, and expands the utility and efficacy of 2,4-(substituted aromatic)-1,3-oxazoline compounds as pesticides.

The following examples serve to explain embodiments of the present disclosure in more detail. These examples are not to be construed as being exhaustive or exclusive as to the scope of this invention.

### EXAMPLES

### Example 1

### Insecticide Utility

Different 2,4-(substituted aromatic)-1,3-oxazoline compounds were tested for insecticidal activity on Spodoptera exigua (beet armyworm) and Myzus persicae (green peach aphid).

The different 2,4-(substituted aromatic)-1,3-oxazoline compounds used on Spodoptera exigua were formulated as test solutions. To prepare the test solutions, the different 2,4-(substituted aromatic)-1,3-oxazoline compounds were formulated at 400 PPM in 7.5 mL of 2:1 acetone:tap water solvent. 250 μL of each test solution was pipetted upon the surface of 8 mL of lepidopteran diet (modified Shorey) contained in each of five one-ounce plastic cups (one cup=1 replication). A second-instar beet armyworm was placed upon the treated diet in each cup once the solvent had air-dried. The cups containing the treated lepidopteran diet and the beet armyworms were capped and then held in a growth chamber at 25° C., 50-55% RH, and 14 hours light:10 hours dark for 5 days. The average % mortality was determined from the number of dead insects of five per treatments. The results are summarized in Table 1.

The different 2,4-(substituted aromatic)-1,3-oxazoline compounds used on Myzus persicae were formulated as test spray solutions. To prepare the test spray solutions, 1 mg of each of the different 2,4-(substituted aromatic)-1,3-oxazoline compounds was dissolved into 1 mL of a 90:10 acetone:ethanol solvent. The resulting solution was added to 19 mL of water containing 0.05% Tween surfactant to produce different 50 PPM spray solutions. Cabbage leaves were inferred with green peach aphid (all life stages) 16-20 hours prior to application of the different spray solutions. The different spray solutions were sprayed on both sides of each infested cabbage leaf with a sweeping action until runoff. The cabbage leaves were allowed to dry and were held for 3 days in a controlled room at 26° C. and 40% RH, after which time the test was graded. Grading was by actual count using a dissecting microscope and comparison of test counts to an untreated check. The average % mortality was then determined. The results are summarized in Table 1. In Table 1, “NT” means insecticidal activity was not tested for the 2,4-(substituted aromatic)-1,3-oxazoline compound at this rate.

TABLE 1
Mortality data

| | | Beet Armyworm | Green Peach Aphid |
|---|---|---|---|
| Rate (PPM): | | 400 | 50 |
| Compound ID# | | Average % mortality | |
| 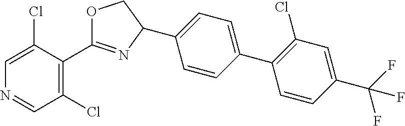 [SMILES: FC(F)(F)c1ccc(-c2ccc(C3COC(c4c(Cl)cncc4Cl)=N3)cc2)c(Cl)c1] | (I) | 100 | 18 |
| 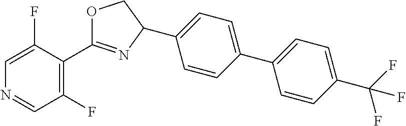 [SMILES: Fc1cncc(F)c1C1=NC(c2ccc(-c3ccc(C(F)(F)F)cc3)cc2)CO1] | (II) | 80 | NT |
| 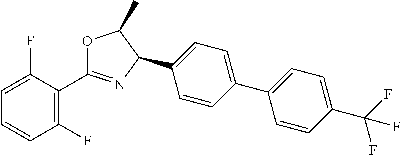 [SMILES: C[C@@H]1OC(c2c(F)cccc2F)=N[C@@H]1c1ccc(-c2ccc(C(F)(F)F)cc2)cc1] | (III) | 100 | 32 |
| 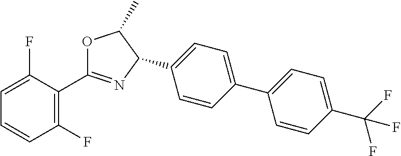 [SMILES: C[C@H]1OC(c2c(F)cccc2F)=N[C@H]1c1ccc(-c2ccc(C(F)(F)F)cc2)cc1] | | | |
| 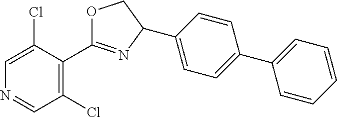 [SMILES: Clc1cncc(Cl)c1C1=NC(c2ccc(-c3ccccc3)cc2)CO1] | (IV) | 80 | NT |
| 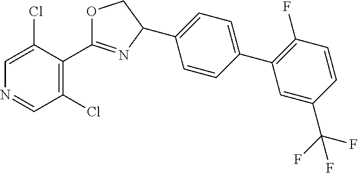 [SMILES: Fc1ccc(C(F)(F)F)cc1-c1ccc(C2COC(c3c(Cl)cncc3Cl)=N2)cc1] | (V) | 60 | NT |
| 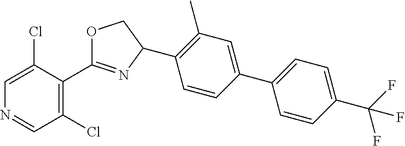 [SMILES: Cc1cc(-c2ccc(C(F)(F)F)cc2)ccc1C1COC(c2c(Cl)cncc2Cl)=N1] | (VI) | 100 | 20 |
| 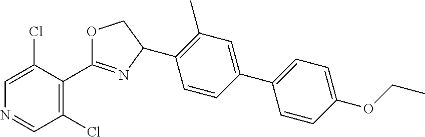 [SMILES: CCOc1ccc(-c2ccc(C3COC(c4c(Cl)cncc4Cl)=N3)c(C)c2)cc1] | (VII) | 100 | 82 |
| 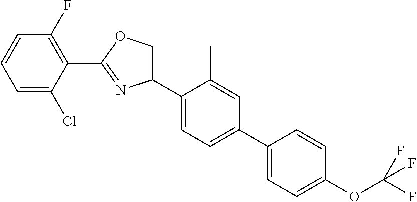 [SMILES: Cc1cc(-c2ccc(OC(F)(F)F)cc2)ccc1C1COC(c2c(F)cccc2Cl)=N1] | (VIII) | 100 | 66 |
| 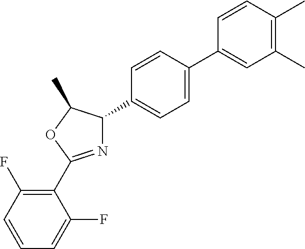 [SMILES: Cc1ccc(-c2ccc([C@@H]3N=C(c4c(F)cccc4F)O[C@H]3C)cc2)cc1C] | (IX) | 60 | 0 |
| 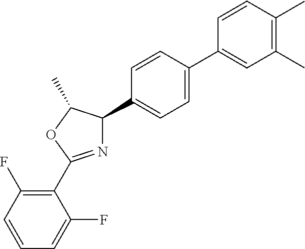 [SMILES: Cc1ccc(-c2ccc([C@H]3N=C(c4c(F)cccc4F)O[C@@H]3C)cc2)cc1C] | | | |
| 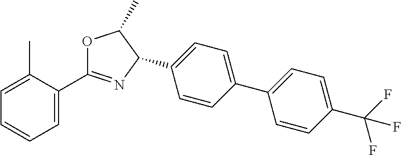 [SMILES: Cc1ccccc1C1=N[C@@H](c2ccc(-c3ccc(C(F)(F)F)cc3)cc2)[C@@H](C)O1] | (X) | 100 | 88 |
| 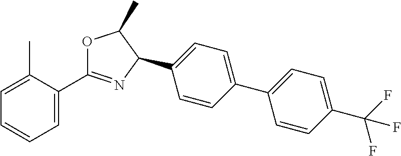 [SMILES: Cc1ccccc1C1=N[C@H](c2ccc(-c3ccc(C(F)(F)F)cc3)cc2)[C@H](C)O1] | | | |
| 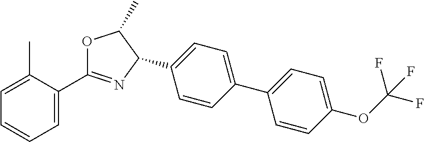 [SMILES: Cc1ccccc1C1=N[C@@H](c2ccc(-c3ccc(OC(F)(F)F)cc3)cc2)[C@@H](C)O1] | (XI) | 100 | 71 |
| 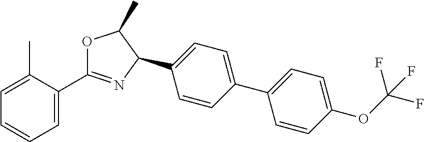 [SMILES: Cc1ccccc1C1=N[C@H](c2ccc(-c3ccc(OC(F)(F)F)cc3)cc2)[C@H](C)O1] | | | |
| 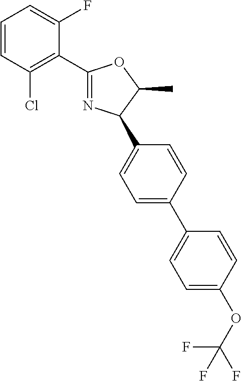 [SMILES: C[C@@H]1OC(c2c(F)cccc2Cl)=N[C@@H]1c1ccc(-c2ccc(OC(F)(F)F)cc2)cc1] | (XII) | 100 | 86 |
| 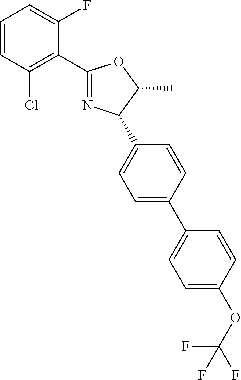 [SMILES: C[C@H]1OC(c2c(F)cccc2Cl)=N[C@H]1c1ccc(-c2ccc(OC(F)(F)F)cc2)cc1] | | | |
| 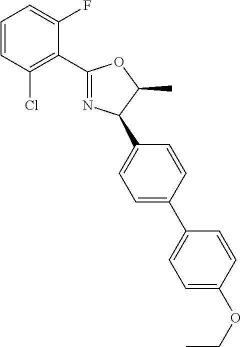 [SMILES: CCOc1ccc(-c2ccc([C@H]3N=C(c4c(F)cccc4Cl)O[C@H]3C)cc2)cc1] | (XIII) | 100 | 82 |
| 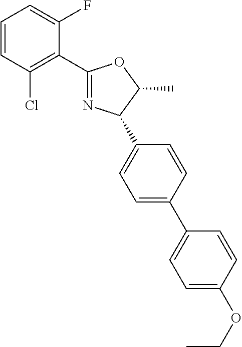 [SMILES: CCOc1ccc(-c2ccc([C@@H]3N=C(c4c(F)cccc4Cl)O[C@@H]3C)cc2)cc1] | | | |
| 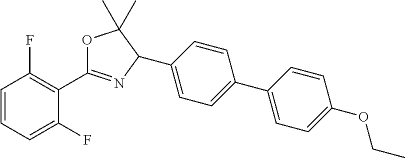 [SMILES: CCOc1ccc(-c2ccc(C3N=C(c4c(F)cccc4F)OC3(C)C)cc2)cc1] | (XIV) | 60 | 40 |
| 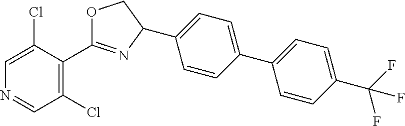 [SMILES: FC(F)(F)c1ccc(-c2ccc(C3COC(c4c(Cl)cncc4Cl)=N3)cc2)cc1] | (XV) | 100 | 75 |
| 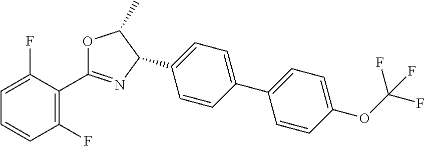 [SMILES: C[C@H]1OC(c2c(F)cccc2F)=N[C@H]1c1ccc(-c2ccc(OC(F)(F)F)cc2)cc1] | (XVI) | 100 | 95 |
| 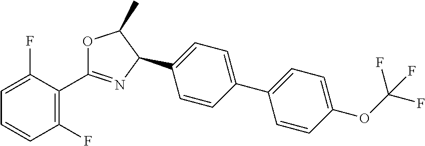 [SMILES: C[C@@H]1OC(c2c(F)cccc2F)=N[C@@H]1c1ccc(-c2ccc(OC(F)(F)F)cc2)cc1] | | | |

While the present disclosure is susceptible to various modifications and alternative forms, specific embodiments have been shown by way of example in the drawings and have been described in detail herein. However, the present disclosure is not intended to be limited to the particular forms disclosed. Rather, the present disclosure is to cover all modifications, equivalents, and alternatives falling within the scope of the present invention as defined by the following appended claims and their legal equivalents.

What is claimed is:

1. A method of controlling pests, comprising:
contacting at least one seed with at least one 2,4-(substituted aromatic)-1,3-oxazoline compound to control at least one pest, the at least one 2,4-(substituted aromatic)-1,3-oxazoline compound comprising the following chemical structure: 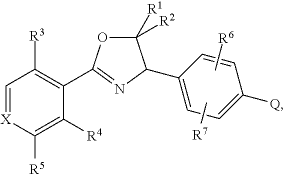
where R¹, R², R³, R⁴, and R⁵ independently comprise H, alkyl, haloalkyl, or halo;
Q is selected from aryl, heteroaryl, substituted aryl, and substituted heteroaryl, wherein said substituents are selected from H, alkyl, haloalkyl, halo, alkoxy, and haloalkoxy;
R⁶, R⁷, R⁸, and R⁹ independently comprise H, alkyl, haloalkyl, halo, alkoxy, or haloalkoxy; and X is C or N.

2. The method of claim 1, wherein contacting at least one seed with at least one 2,4-(substituted aromatic)-1,3-oxazoline compound comprises contacting the at least one seed with the at least one 2,4-(substituted aromatic)-1,3-oxazoline compound to control members of Phylum Arthropoda.

3. The method of claim 2, wherein contacting the at least one seed with the at least one 2,4-(substituted aromatic)-1,3-oxazoline compound comprises contacting the at least one seed with the at least one 2,4-(substituted aromatic)-1,3-oxazoline compound to control members of at least one of Class Insecta and Class Arachnida.

4. The method of claim 3, wherein contacting the at least one seed with the at least one 2,4-(substituted aromatic)-1,3-oxazoline compound comprises contacting the at least one seed with the at least one 2,4-(substituted aromatic)-1,3-oxazoline compound to control at least one of members of Orders Coleoptera, Dermaptera, Dictyoptera, Diptera, Hemiptera, Homoptera, Hymenoptera, Isoptera, Lepidoptera, Orthoptera, Thysanoptera, Thysanura, and Acari.

5. The method of claim 4, wherein contacting the at least one seed with the at least one 2,4-(substituted aromatic)-1,3-oxazoline compound comprises contacting the at least one seed with the at least one 2,4-(substituted aromatic)-1,3-oxazoline compound to control at least one of members of Orders Homoptera, Lepidoptera, and Acari.

6. The method of claim 5, wherein contacting the at least one seed with the at least one 2,4-(substituted aromatic)-1,3-oxazoline compound comprises contacting the at least one seed with the at least one 2,4-(substituted aromatic)-1,3-oxazoline compound to control at least one of Spodoptera spp. and Myzus spp.

7. The method of claim 1, wherein the at least one seed is produced from a plant in at least one of genuses Allium, Antirrhinum, Arachis, Asparagus, Avena, Begonia, Beta, Betholettia, Brassica, Capsicum, Carthamus, Chrysanthemum, Cicer, Cichorium, Citrillus, Coriandrum, Cocus, Cucumis, Cucurbita, Cyclamen, Daucus, Dianthus, Elaeis, Gazania, Gerbera, Glycine, Gossypium, Helianthus, Hordeum, Impatiens, Ipomoea, Lactuca, Lavatera, Lens, Lobelia, Lolium, Medicago, Nicotiana, Olea, Oryza, Pelargonium, Petunia, Phaseolus, Pisum, Phlox, Poa, Primula, Raphanus, Ricinus, Salvia, Secale, Simmondsia, Solanum, Sorghum, Spinacia, Tageta, Trifolium, Triticale, Triticum, Valerianella, Verbena, Viciam, Vinca, Viola, Zea, and Zinnia.

8. The method of claim 1, wherein contacting at least one seed with at least one 2,4-(substituted aromatic)-1,3-oxazoline compound comprises applying the at least one 2,4-(substituted aromatic)-1,3-oxazoline compound to the at least one seed before sowing the at least one seed.

9. The method of claim 1, wherein contacting at least one seed with at least one 2,4-(substituted aromatic)-1,3-oxazoline compound comprises at least one of spraying, coating, dusting, and soaking the at least one seed with the at least one 2,4-(substituted aromatic)-1,3-oxazoline compound.

10. The method of claim 1, wherein contacting at least one seed with at least one 2,4-(substituted aromatic)-1,3-oxazoline compound comprises applying multiple applications of the at least one 2,4-(substituted aromatic)-1,3-oxazoline compound to the at least one seed.

11. The method of claim 1, wherein contacting at least one seed with at least one 2,4-(substituted aromatic)-1,3-oxazoline compound comprises contacting the at least one seed with a formulation comprising the at least one 2,4-(substituted aromatic)-1,3-oxazoline compound and at least one inert carrier.

12. The method of claim 11, wherein the formulation further comprises at least one adjuvant material.

13. The method of claim 11, wherein the formulation further comprises at least one additional pesticide.

14. A method of controlling pests, comprising:
applying a 2,4-(substituted aromatic)-1,3-oxazoline compound to at least one seed to control at least one insect species, the 2,4-(substituted aromatic)-1,3-oxazoline compound comprising the following chemical structure: 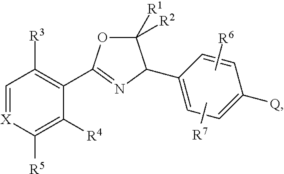
where R¹, R², R³, R⁴, and R⁵ independently comprise H, alkyl, haloalkyl, or halo;
Q is selected from aryl, heteroaryl, substituted aryl, and substituted heteroaryl, wherein said substituents are selected from H, alkyl, haloalkyl, halo, alkoxy, and haloalkoxy;
R⁶, R⁷, R⁸, and R⁹ independently comprise H, alkyl, haloalkyl, halo, alkoxy, or haloalkoxy; and X is C or N.

15. The method of claim 14, wherein applying the 2,4-(substituted aromatic)-1,3-oxazoline compound to at least one seed comprises applying the 2,4-(substituted aromatic)-1,3-oxazoline compound to the at least one seed concurrently with at least one additional material.

16. The method of claim 14, wherein applying the 2,4-(substituted aromatic)-1,3-oxazoline compound to at least one seed comprises applying the 2,4-(substituted aromatic)-1,3-oxazoline compound to the at least one seed consecutively with at least one additional material.

17. The method of claim 14, wherein the at least one insect species comprises a species within at least one of the Orders Homoptera and Lepidoptera.

18. The method of claim 14, wherein the at least one insect species comprises at least one of Myzus persicae and Spodoptera exigua.

19. A method of seed treatment, comprising:
contacting at least one seed with at least one of an insecticidally effective amount and a miticidally effective amount of a 2,4-(substituted aromatic)-1,3-oxazoline compound to substantially protect the at least one seed and plant parts developing therefrom from damage effectuated by at least one of insects and mites, the 2,4-(substituted aromatic)-1,3-oxazoline compound comprising the following chemical structure: 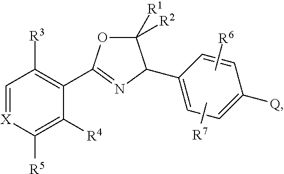
where R¹, R², R³, R⁴, and R⁵ independently comprise H, alkyl, haloalkyl, or halo;
Q is selected from aryl, heteroaryl, substituted aryl, and substituted heteroaryl, wherein said substituents are selected from H, alkyl, haloalkyl, halo, alkoxy, and haloalkoxy;
R⁶, R⁷, R⁸, and R⁹ independently comprise H, alkyl, haloalkyl, halo, alkoxy, or haloalkoxy; and X is C or N.

20. The method of claim 19, wherein contacting the at least one seed with at least one of an insecticidally effective amount and a miticidally effective amount of the 2,4-(substituted aromatic)-1,3-oxazoline compound comprises applying a formulation comprising the 2,4-(substituted aromatic)-1,3-oxazoline compound, at least one inert carrier, at least one adjuvant material, and at least one additional pesticide to the at least one seed.
